(19) United States
(12) Patent Application Publication
(10) Pub. No.: US 2024/0112098 A1
(43) Pub. Date: Apr. 4, 2024

(54) UNIFIED SYSTEM FOR COMPREHENSIVE BRAND EXPERIENCE AND CUSTOMER EXPERIENCE ANALYSIS AND MEASUREMENT

(71) Applicant: Proper Villains, LLC, Boston, MA (US)

(72) Inventor: Jeffrey Scott Monahan, Newburyport, MA (US)

(21) Appl. No.: 18/478,944

(22) Filed: Sep. 29, 2023

Related U.S. Application Data
(60) Provisional application No. 63/378,065, filed on Oct. 1, 2022.

(51) Int. Cl. G06Q 10/063; G06Q 30/0203; G06Q 30/0204

(52) U.S. Cl. CPC G06Q 10/063; G06Q 30/0203; G06Q 30/0204

(57) ABSTRACT

Method and computer-readable media for assessing brand experience and customer experience as a tool to measure and align business intentions with customer experiences. A central processing system provides, via a communication interface, a set of questions for a multiple element brand design assessment from a central system to multiple remote user terminals. The central processing system receives, via the communication interface, a set of user selectable response from each of the multiple remote user terminals in response to the provided set of questions. The central processing system combines scores based on the set of user selectable responses receive from each of the multiple remote user terminals to generate metrics for assessed elements of the multiple element brand design assessment. The central processing system outputs a report comprising the metrics for the assessed elements of the multiple element brand design assessment.

### CROSS REFERENCE TO RELATED APPLICATION(S)

This application claims the benefit of and priority to U.S. Provisional Application Ser. No. 63/378,065, entitled “Unified Brand Design” and filed on Oct. 1, 2022, which is expressly incorporated by reference herein in its entirety.

### INTRODUCTION

An organization's brand encourages consumers to purchase products, supports marketing and advertising, affects employee satisfaction and longevity, and makes the organization memorable. Designing, building, and maintaining a brand is a core operation that affects the success of the organization. Greater insight and efficiencies are needed for tools to assisting organizations in assessing the effectiveness of brands, products, services, and programs.

### SUMMARY

Aspects disclosed herein include a method, system, and computer-readable media for assessing brand experience and customer experience as a tool to measure and align business intentions with customer experiences. A central processing system provides, via a communication interface, a set of questions for a multiple element brand design assessment from a central system to multiple remote user terminals. The central processing system receives, via the communication interface, a set of user selectable response from each of the multiple remote user terminals in response to the provided set of questions. The central processing system combines scores based on the set of user selectable responses receive from each of the multiple remote user terminals to generate metrics for assessed elements of the multiple element brand design assessment. The central processing system outputs a report comprising the metrics for the assessed elements of the multiple element brand design assessment.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a diagram showing a comprehensive brand design assessment system that includes a communication interface that sends a set of targeted assessment questions relating to a brand experience or customer experience in order to generate a report and recommendation for an organization 130 associated with the brand, in accordance with various aspects of the present disclosure.

FIG. 2 is a diagram 200 that illustrates additional details regarding an example comprehensive brand design assessment system that may be configured to perform the aspects presented herein.

FIG. 3 illustrates an example of a leadership team for an organization, in accordance with various aspects of the present disclosure.

FIG. 4 illustrates an example brand intention architecture 400 for an example organization, in accordance with various aspects of the present disclosure.

FIG. 5A illustrates one architectural view of a customer that engages with an organization through transactions, in accordance with various aspects of the present disclosure.

FIG. 5B illustrates an architectural view that considers a customer experience, a cultural experience, and a community experience with an organization, in accordance with various aspects of the present disclosure.

FIG. 6 is a block diagram illustrating a life-centered design thinking lens, in accordance with various aspects of the present disclosure.

FIG. 7 illustrates that a multi-dimensional lens may be applied to the 3CX model to separately assess the customers, cultures, and communities using an individual lens, in accordance with various aspects of the present disclosure.

FIG. 8 illustrates that the tool, including sending inquiries to multiple users and combining responses per element and in an overall combination, may be used at various times including at design and assessment stages, in accordance with various aspects of the present disclosure.

FIG. 9 is a block diagram illustrating an example of grouping audiences for a brand, product, or service, in accordance with various aspects of the present disclosure.

FIG. 10 illustrates an example question that may be included in a template and/or provided to a remote use to obtain a user selected score relating to the thoughtful characteristic, in accordance with various aspects of the present disclosure.

FIG. 11 illustrates an example of a numerical value that can be applied for each user selected phrase in response to the various questions provided to the user to determine a life-centered design thinking score, in accordance with various aspects of the present disclosure.

FIG. 12 illustrates that a net promotor question may be presented to the user, and the user selectable option may include a scale of values, in accordance with various aspects of the present disclosure.

FIG. 13 illustrates an example scale for a net promoter score and shows the grouping of values into groups of promoters, passives, and detractors, in accordance with various aspects of the present disclosure.

FIG. 14 illustrates an example spreadsheet type report that may be provided, in accordance with various aspects of the present disclosure.

FIG. 15 is an example flowchart of a method of assessing life-centered design program or brand, in accordance with various aspects of the present disclosure.

FIG. 16 is a block diagram illustrating a general-purpose computer system 620 on which aspects of systems and methods for providing sets of questions for assessing brand and customer experience, receiving the user selected responses, generating a combined set of scores based on the received responses, in accordance with various aspects of the present disclosure.

### DETAILED DESCRIPTION

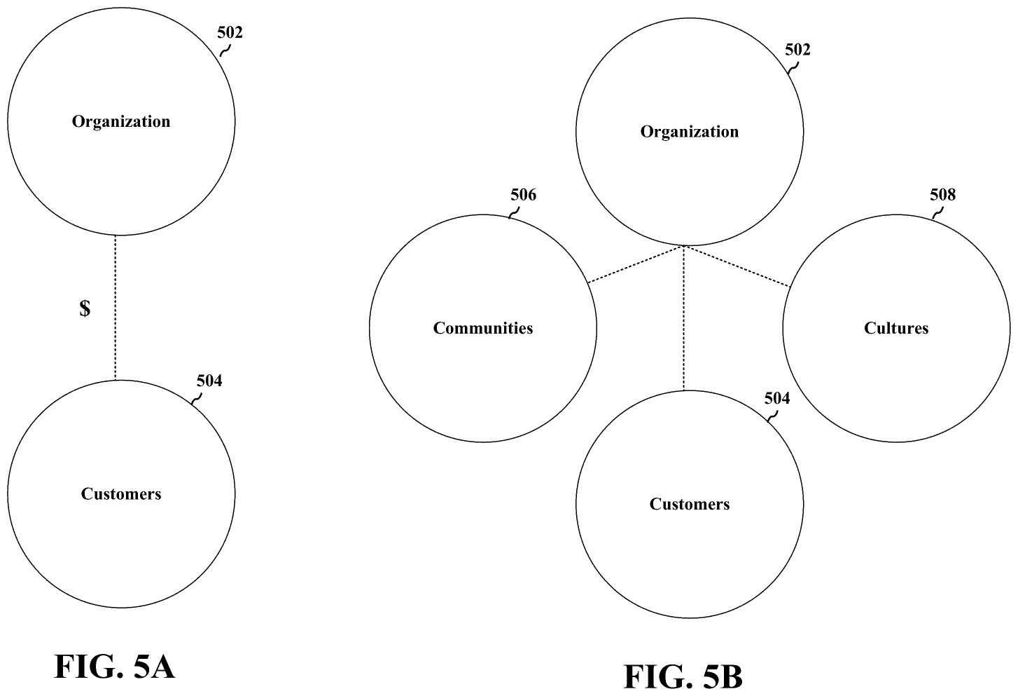

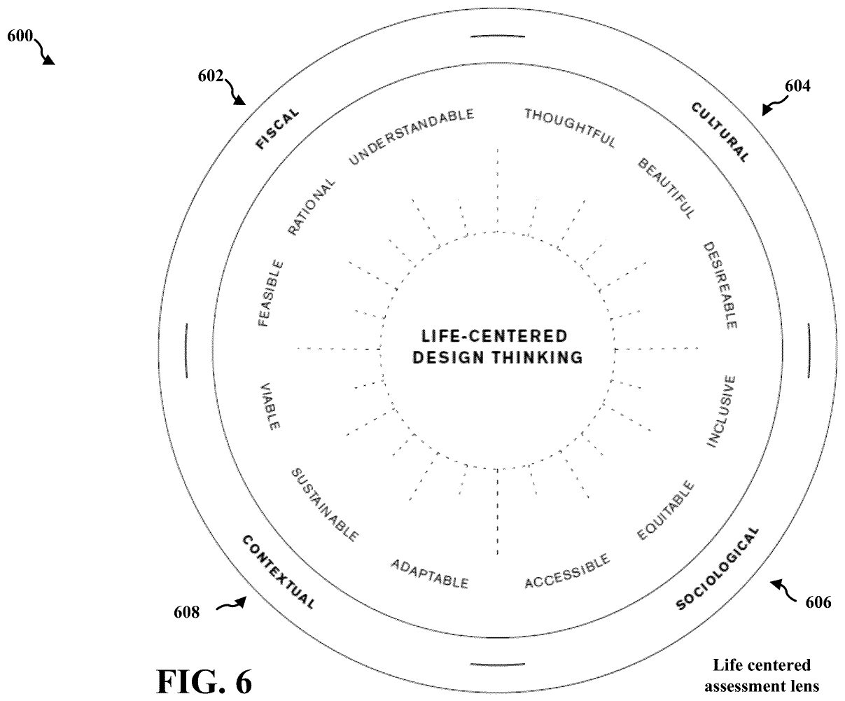

Aspects presented herein include a system that provides a tool for systematically planning for the authentic development of a brand experience (BX), in alignment with its intentions, strategies, and goals. The system provides a tool that assists an organization in designing a customer experience (CX), including thoughtfully expressing BX principals as frameworks and assets that inform and engage its audiences. The system includes a communication interface that sends questions to multiple remote user terminals and receives responses to the questions from the remote user terminals to generate an assessment of the customer experience through a lens that considers multiple focus areas and underlying elements, as described in more detail in connection with FIG. 6. The system provides baseline assessment tools, and the output report and recommendations that enable a central system to assess various element of experience relating to a brand intention for an organization by querying groups of persons, e.g., at remote user terminals, and combining the responses for each element to report a set of recommendations from the central system to a user at the organization for each element of the example lens described in connection with FIG. 6. The questions submitted to the remote user terminals, and the report that is provided to the organization user is based on a brand intention architecture, customer experience from multiple groups that interact with the organization (e.g., which may be referred to as 3CX as described in connection with FIG. 5B), and life-centered design factors/analysis. The system and report enable a tangible assessment and report that identifies progress for various elements of customer experience to assist the organization in creating alignment between business intentions, brand experiences, and customer experiences. The combination of BX and CX can be used to realign organization goals and foster cross-functional collaboration. The system presented herein provides a targeted report with a functional and comprehensive framework for making BX and CX programs. Life-centered design elements can accommodate broad complexities, accelerate changes, and illustrate a holistic point of view.

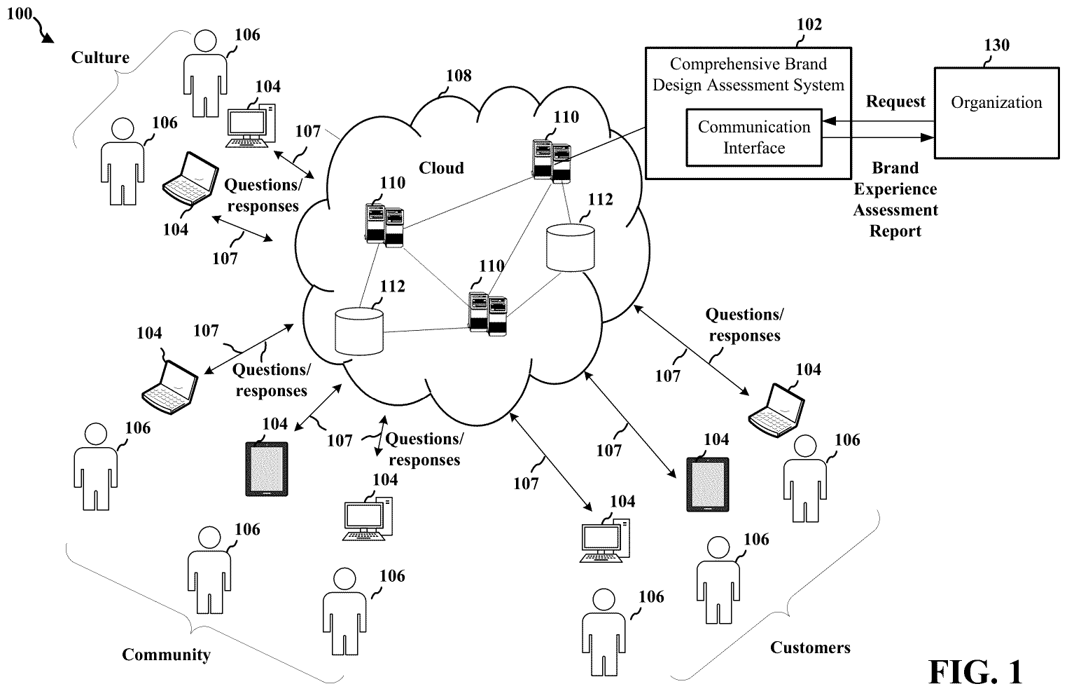

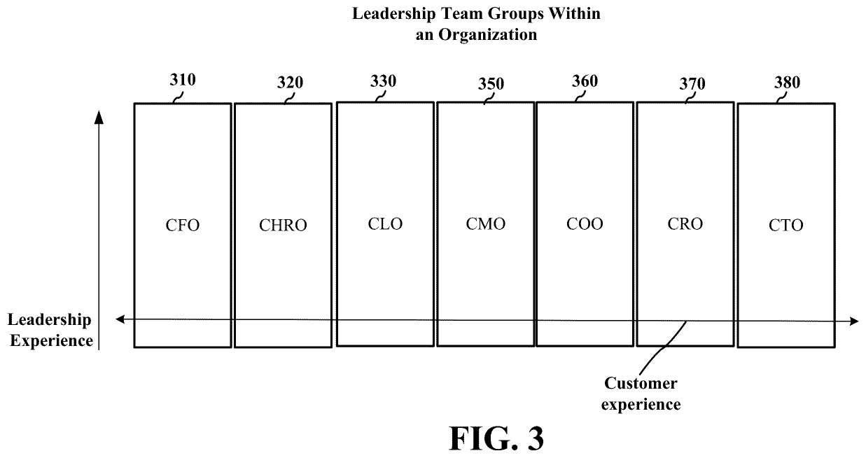

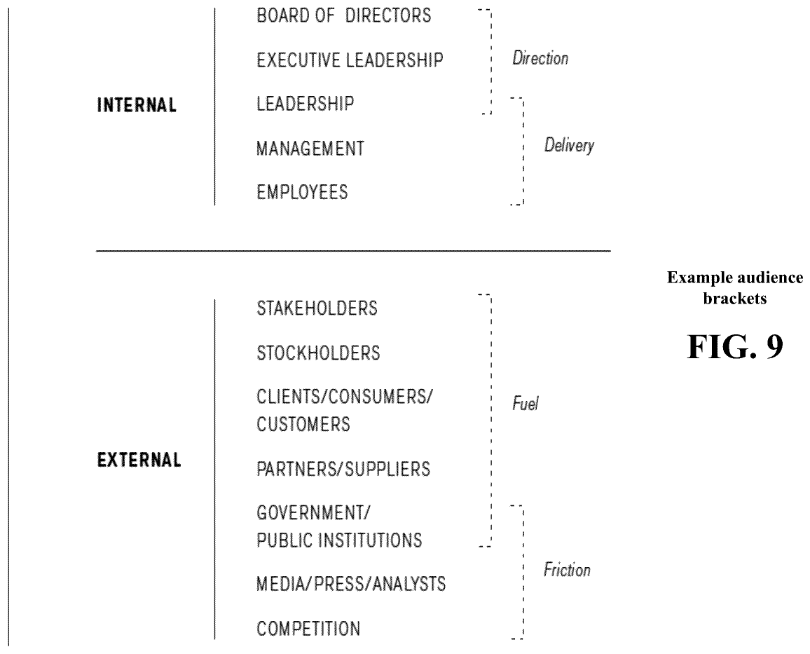

FIG. 1 illustrates a diagram 100 showing a comprehensive brand design assessment system 102 that includes a communication interface that sends a set of targeted assessment questions relating to a brand experience or customer experience in order to generate a report and recommendation for an organization 130 associated with the brand. As illustrated, the comprehensive brand design assessment system 102 may send a set of assessment questions, e.g., as described in connection with any of FIGS. 3-15, to multiple remote user terminals 104 to obtain response for a set of elements and focus areas relating to brand experience and customer experience from multiple accessors (e.g., 106) (which may also be referred to as users or people, among other descriptions). The comprehensive brand design assessment system 102 transmits the set of questions via the communication interface and a communication connection 107 to the remote terminal devices. The communication connection or communication interface allows software and data to be transferred between computer systems or user devices and external devices. Examples of communications interfaces may include a modem, a network interface (such as an Ethernet card), a communications port, a Personal Computer Memory Card International Association (PCMCIA) slot and card, etc. Software and data can be transferred via communications interfaces in the form of signals, which may be electronic, electromagnetic, optical or other signals capable of being received by communications interface. These signals can be provided to communications interface via a communications path (e.g., channel). The communication interface may include a model, a network interface, a communications port, and/or other components to enable the exchange of communication via a communication path (e.g., whether wire, cable, fiber optic, wireless link, and/or other communication channel between computer systems).

The diagram shows a communication system that may support multiple and one or more user devices (which may also be referred to as terminals 104). As the user devices are separate from, and may be at any distance from, the comprehensive brand design assessment system, the terminals 104 may be referred to as remote terminals, e.g., that are remote from the system 102. Among other examples, the remote user terminals may include devices such as personal computers (PCs), minicomputers, mainframe computers, microcomputers, telephonic devices, or wireless devices, such as personal digital assistants (“PDAs”) or a hand-held wireless devices coupled to a server 110 or other device having a processor and a repository for data and/or connection to a repository for data, via, for example, a network 108, such as the Internet and couplings. The couplings include, for example, wired, wireless, or fiber optic links. FIG. 1 illustrates an example in which various remote user devices may connect to the comprehensive brand design assessment system 102 via a cloud (e.g., 108) that may include one or more servers 110 and databases 112.

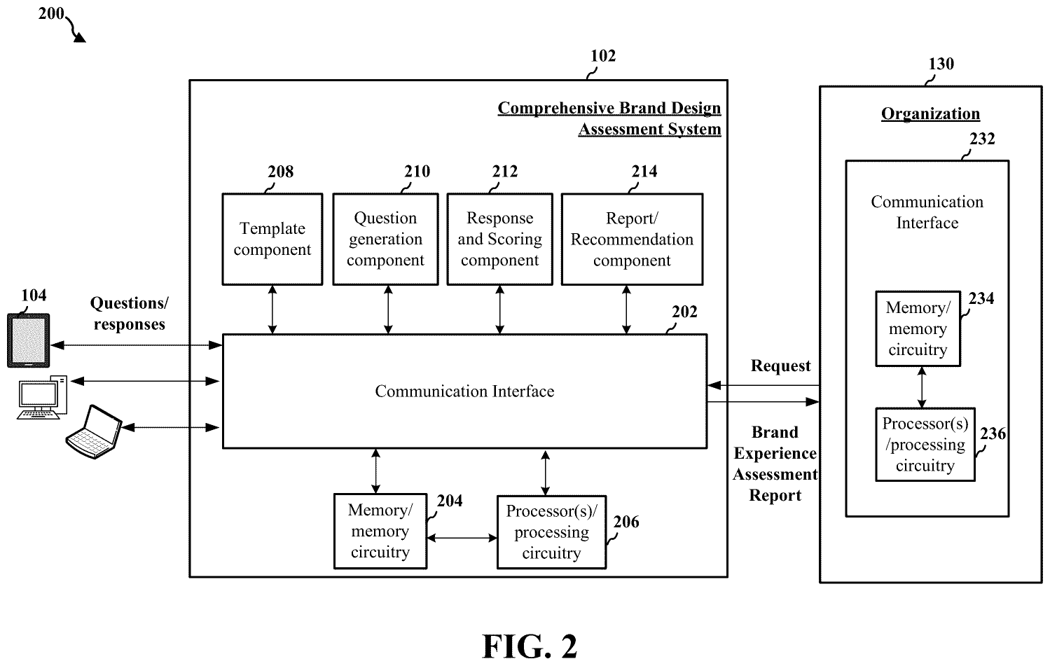

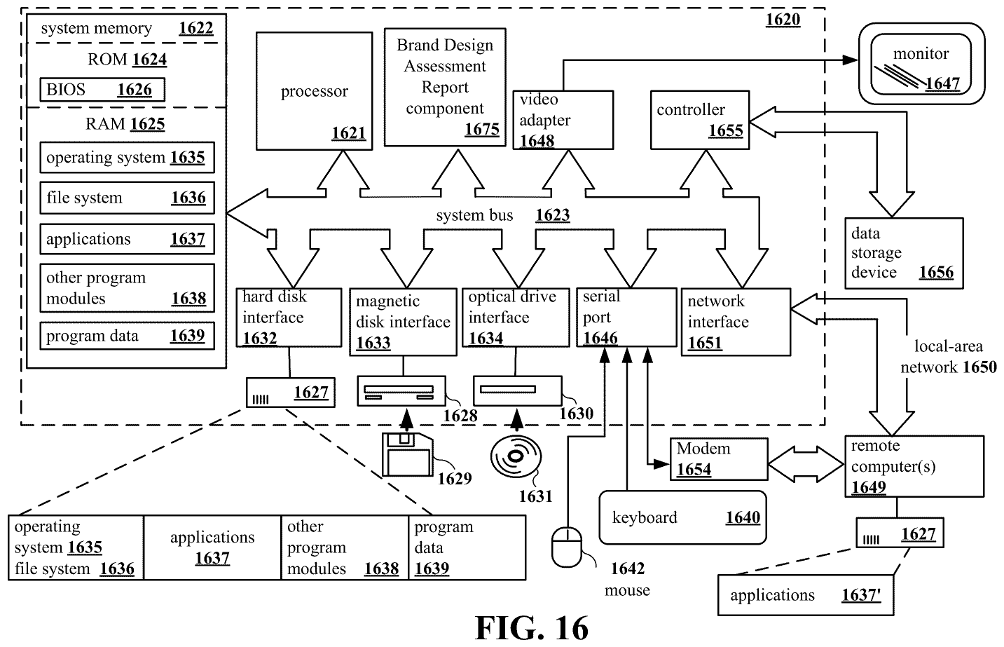

FIG. 2 is a diagram 200 that illustrates additional details regarding an example comprehensive brand design assessment system 102 that may be configured to perform the aspects presented herein. As illustrated, the system 102 may include memory 204 (or memory circuitry) and one or more processors 206 (or processor circuitry) configured to cause the computer system to perform the aspects described in connection with any of FIGS. 3-15. The system 102 may further include one or more of the example hardware components of a computer system described in connection with FIG. 16. In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

As described in connection with FIG. 1, the system 102 may include a communication interface 202 configured to provide a connection that allows for the exchange of data between the system 102 and multiple remote terminals 104 in order to transmit the set of questions to multiple persons that interact with or experience the organization's brand and to receive responses from the remote user terminals 104. In some aspects, the communication interface may further enable the exchange of data between the organization 130 and the system 102. For example, the organization 130 may further include a communication interface 232, e.g., which may include memory 234 and/or processing circuitry 236. In some aspects, the organization may transmit a request to the comprehensive brand design assessment system 102 for an initial and/or follow up measurement of brand experience, as described herein. In some aspects, the system 102 may respond by sending a brand experience assessment report and recommendations to the organization. The system 102 may include a template component 208 that is configured to store, maintain, update, and/or access a template for generating sets of questions to be sent to the multiple remote user interfaces, as described herein. The system 102 may include a question generation component 210, which may access a version of the template and present options to a user in generating a set of questions that are targeted for a particular brand, product, service, or organization. In some aspects, the question generation component 210 may provide the sets of questions via the communications interface to the multiple remote user terminals 104. The system 102 may include a response and scoring component 212 that receives the responses from the remote user terminals 104 that are received via the communication interface 202. The response and scoring component 212 may be configured to translate the received responses into a numerical score and to combine scores for one or more groups of participants to generate metrics, as described herein. The system 102 may include a report and recommendation component 214 that is configured to output a report that illustrates and or summarizes metrics based on the combination of responses from the remote user terminals, e.g., as described herein.

The aspects presented herein provide an architecture or platform for designing and assessing brand intention. The tools presented herein assist a user in creating alignment between business intentions, brand experiences, and customer experiences as a tool to improve an organization. The tool includes component to create targeted assessment questions that are provided to multiple people, such as via a communication component, and to receive and compile the responses. The tool enables the creation of a visual report based on a combination of brand intention or brand experience (BS) and customer experience (CX). The combination of BX and CX in the assessment can help to realign organizational thinking and foster cross-functional collaboration.

FIG. 3 illustrates an example of a leadership team for an organization. Leadership

teams may include positions, or functions, for one or more of a chief financial officer (CFO) position 310, a chief human resources officer (CHRO) position 320, a chief learning officer (CLO) position 330, a chief marketing officer (CMO) position 350, a chief operating officer (COO) position 360, a chief revenue officer (CRO) position 370, and a chief technology officer (CTO) position 380. FIG. 3 illustrates that the leadership experience increases within a particular leadership area. FIG. 3 also illustrates that the customer experience with an organization, cuts across, or is affected by decisions from each of the leadership groups, or positions, within an organization. The assessment tool presented herein includes elements to identify and assess the effect on customer experience.

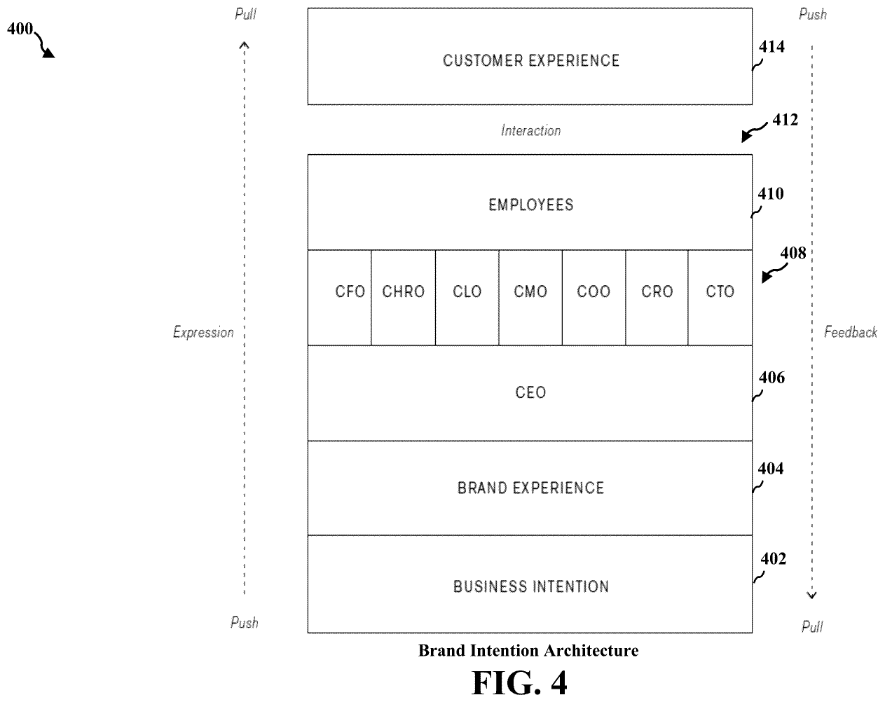

FIG. 4 illustrates an example brand intention architecture 400 for an example organization. In FIG. 4, the architecture includes a business intention 402 base on which a brand experience 404 is structured. A chief executive officer 406 and a leadership team 408 including a CFO, CHRO, CLO, CMO, COO, CRO, and CTO, e.g., as described in connection with FIG. 3. The structure includes other employees 410 of the organization and shows that the employees have the direct interaction 412 with customers 414. The customer experience with the organization is based on the interactions with the employees. FIG. 4 illustrates a push to affect the customer experience based on decisions and actions that start or initiate with the business intention 402, through business decisions of the CEO 406, and leadership team 408 toward the employees 410 that more directly interact with the customer 414. FIG. 4 also illustrates the push of feedback from the customers 414 toward employees 410, leadership teams 408, and the CEO 406. Such feedback may affect the business intention 402.

The brand assessment architecture and tools presented herein illuminate a comprehensive and connected view of various audience types for an organization. The architecture and platform presented herein applies a new meaning of a term “customer” when assessing customer experience of a brand. FIG. 5A illustrates one architectural view of a customer 504 that engages with an organization 502 through transactions, e.g., financial transactions such as purchases, or subscriptions, among other examples. The relationship between the customer and the organization in FIG. 5A may be defined as transactional or financial. FIG. 5B illustrates an architectural view that considers a customer experience (e.g., 504), a cultural experience (e.g., 508), and a community experience (e.g., 506) with an organization 502. Communities 506 may include non-paying (or non-transactional) groups, such as users. For examples, users may include non-paying users such as social media users or other people that interact with a product, service, or brand without making a purchase or payment. In some aspects, community may include employees, a board of directors, and shareholders, among other examples. Cultures 508 may include employees and other sociological audiences. In some aspects, the model illustrated in FIG. 5A may be referred to a 3CX model. The assessment tools presented herein may be configured to transmit assessment questions to remote terminals for various groups of people, including groups that include customers, communicates, and cultures that are associated with an organization or brand. For example, FIG. 1 illustrates the remote user terminals 104 and associated people 106 in groups, e.g., for customers, culture, and community, as described in connection with FIG. 5B.

The brand assessment architecture and tools presented herein may include the transmission and reception of assessment materials and the creation of visual representations and reports based on life-centered design thinking, which can provide a functional and comprehensive framework for creating and measuring business intention and customer experience programs (e.g., including 3CX based assessments). Such life-centered design thinking can accommodate broad complexities, accelerate changes, and provide a holistic point of view of an organization.

In some aspects, the architecture presented herein may enable the generation and storage, e.g., at a comprehensive brand design assessment system 102, of templates for assessments based on concepts of design thinking, human centered design, and experience design as a single construct. In some aspects, the architecture presented herein may capture an essence of a foundational thinking in a formal construct that is contemporary, adaptable, and capable of being utilized as a functional framework for business intention and customer experience programs.

Various constructs may be considered for design, including among other potential considerations, design as a principle, design as a corporate identifier/philosophy (e.g., including characteristics for consideration such as thoughtful, rational, beautiful, feasible, desirable relating to the design). Other considerations may include design as an advertising technique, which can include an added consideration of a viable characteristic along with the other considered characteristics such as thoughtful, rational, beautiful, feasible, desirable. Other considerations may include design as a business ethos, design as a customer experience, design as expression, customer experience design, the design of business, and/or life-centered design. Such considerations may include an added consideration of characteristics such as sustainability and accessibility along with the other characteristics of a brand, such as viable, thoughtful, rational, beautiful, feasible, desirable. In some aspects, design may be considered as a methodology for action (e.g., massive change network), design as material ecology, and/or design as foresight. Such considerations may further include the consideration of inclusivity, equitability, adaptability, and understandability along with the consideration of other aspects such as sustainability, accessibility, viability, thoughtful, rational, beautiful, feasibility, and desirability. A template may be stored that includes targeted questions to prompt persons in one or more groups, e.g., customers, culture, and/or community, to provide a score value response relating to each of the various characteristics described above. The system may then generate a set of targeted questions for a particular brand, transmit the targeted set of questions, via a communication interface, to multiple user devices and to receive their responses. The responses may then be compiled and analyzed to view the organization and brand through a structured lens.

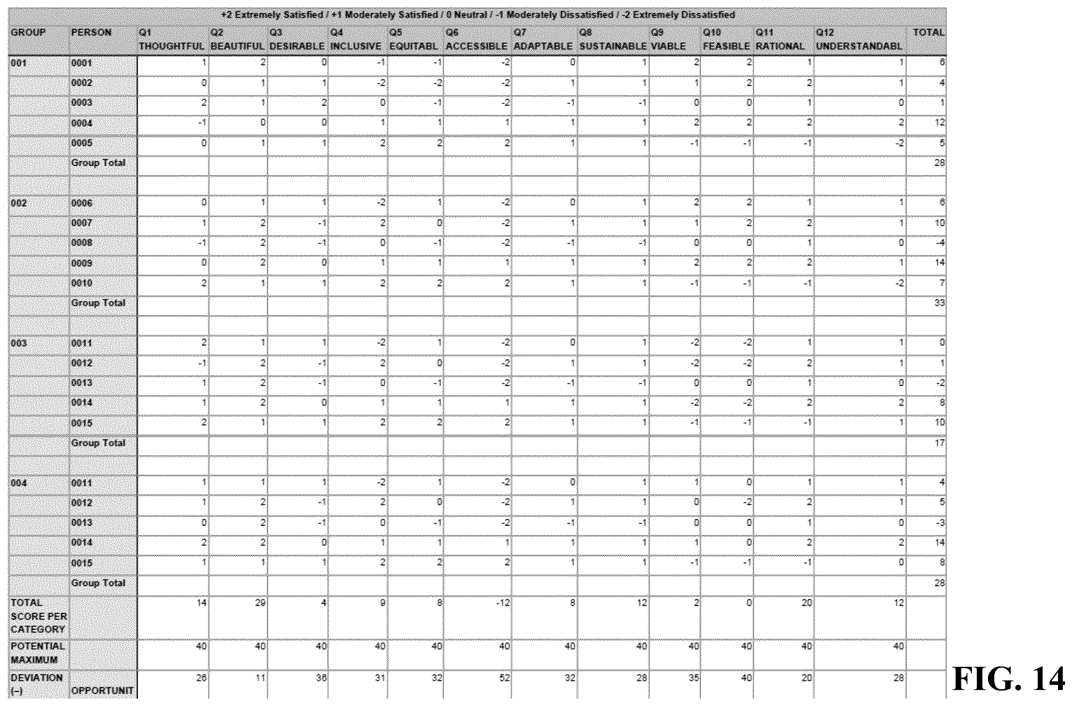

FIG. 6 illustrates an example lens structure 600 for assessing life-centered design for organizations. The structure presented in FIG. 6 may be used to illustrate an assessment of brand intent, and may be assessed for C3X, as presented herein. For example, the assessment may be transmitted to multiple groups of user devices, e.g., and the responses may be grouped for the different (e.g., three) groups described in connection with FIG. 5B. In some aspects, a report based on the responses from the user devices may include a visual representation of the results based on FIG. 6, and showing calculated scores for each element of the lens structure 600. In other examples, the system 102 may output a report, e.g., as shown in FIG. 1 or 2, with summaries of the combined scores. The report may include lists or graphs. In some aspects, the report may include a spreadsheet or table representation of the scores. FIG. 14 illustrates an example spreadsheet type report that may be provided, e.g., as discussed in further detail below.

FIG. 6 illustrates a set of focus areas in an outer ring , e.g., including a fiscal focus area 602, a cultural focus area 604, a sociological focus area 606, and a contextual focus area 608. These focus areas cover broad concepts that an organization might consider in its effort to become a complete and modern brand. These focus areas provide directionality to the elements within the lens, e.g., shown at inner circles in FIG. 6.

Within the next ring of the lens illustrated in FIG. 6, multiple elements or characteristics for consideration are listed, including feasible, rational, understandable, thoughtful, beautiful, desirable, inclusive, equitable, accessible, adaptable, sustainable, and viable. The elements include specific, definable, and measurable elements of brand intentions and attributes. These elements provide guidance and structure the various qualities of brand, product, and service. The elements can be used to created targeted questions that are sent to the multiple remote user devices (e.g., 104), as described in connection with FIG. 1 and FIG. 2. The responses can be combined to provide a measurement of a brand, product, service, or program.

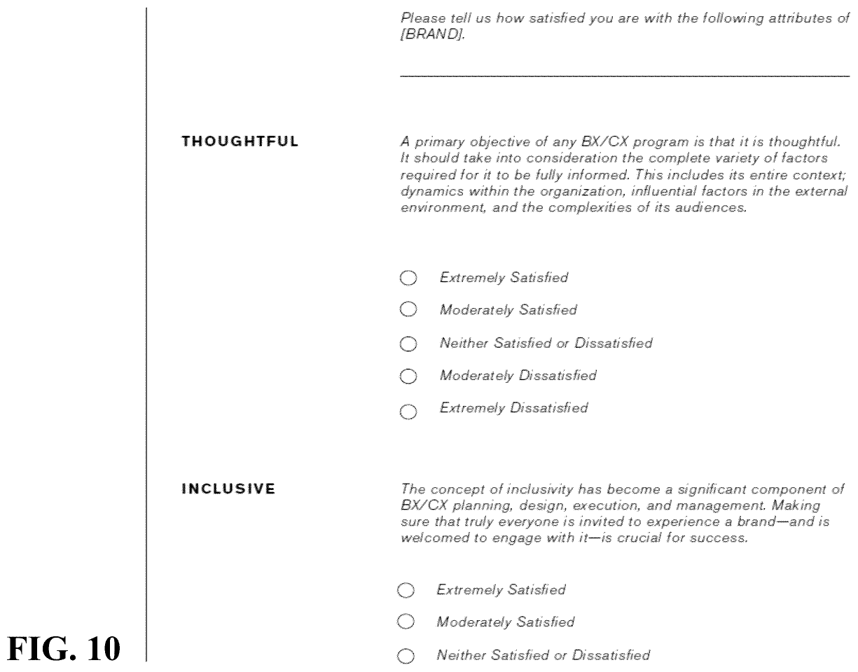

As an example, the elements of thoughtful, beautiful, and desirable are shown as elements under the cultural focus area. The thoughtful element may be measured as a primary objective of a BX/CX program, taking into consideration the complete variety of factors required for the thoughtful element to be fully informed. This includes context, dynamics within the organization, influential factors in the external environment, and the complexities of the audience being assessments. FIG. 10 illustrates an example question that may be included in a template and/or provided to a remote use to obtain a user selected score relating to the thoughtful characteristic. For example, a question may be transmitted to the remote user terminal and presented, e.g., displayed to the user, at a user interface, window, or display of the user terminal. The question may ask the user to select a score, whether a value or phrase asking whether a brand, product, or service takes into consideration the complete variety of factors required for it to be fully informed. FIG. 10 illustrates an example in which a set of user selectable phrases are presented to the user, including: extremely satisfied, moderately satisfied, neither satisfied or dissatisfied, moderately dissatisfied, and extremely dissatisfied. The user may select one on the options at the remote user terminal, and the selection may be transmitted via a communication connection to the system 102 that sent the question. In some aspects, the user selected phrase may be translated into a numerical value in order to combine the answers from multiple people. Although a single question is depicted, one or more questions may be directed to the consideration of thoughtful in order to elicit multiple response from each person relating to the thoughtful consideration.

The beautiful element may include an assessment of a variety of characteristics such as bold or casual, quiet or formal, direct or practical. In this context, the element of beauty may refer to intellectual elegance and executional rigor, which might be executed in a number of different aesthetic directions. One or questions may be provided to the remote user terminals to obtain a user selected response relating to the beautiful characteristic for the product, service, brand, or organization.

The desirable element may be assessed for various meanings. For a BX/CX program, the desirable element may be based on eliciting a response from the audience that is appropriate, enthusiastic, and meaningful. Consideration of the desirable characteristic may involve solutions that are the best, or optimal, example of a brand's intentions. One or questions may be provided to the remote user terminals to obtain a user selected response relating to the desirable characteristic for the product, service, brand, or organization.

In FIG. 6, the elements of inclusive, equitable, and accessible are illustrated under the sociological focus area. The inclusive element may include a consideration of BX/CX planning, design, execution, and management to ensure that truly everyone is invited to experience a brand, and is welcomed to engage with the brand, which can have a strong effect on success. One or questions may be provided to the remote user terminals to obtain a user selected response relating to the beautiful characteristic for the product, service, brand, or organization. FIG. 10 illustrates an example in which a question may ask the user to indicate whether they consider everyone to be invited to experience and welcome to engage with the brand, product, service, etc.

The equitable element may include a consideration of whether internal and external audiences feel that a brand provides fair access and opportunities. The element may include a consideration of all people from all backgrounds and beliefs, with all levels of ability. Thoughtful standards can be designed to guide program implementation and nurturing. One or questions may be provided to the remote user terminals to obtain a user selected response relating to the equitable characteristic for the product, service, brand, or organization.

The accessible element may correspond to a BX/CX program design that assesses whether everyone can access a brand's products and services. In the same way that a person's abilities should not define who they are, the ability of a product or service to be accessed should not define which audiences might access it. One or questions may be provided to the remote user terminals to obtain a user selected response relating to the accessible characteristic for the product, service, brand, or organization.

FIG. 6 shows the contextual focus area including adaptable, sustainable, and viable elements. The adaptable element considers, that as the pace of change continues to quicken, successful brands will develop the skills to be prepared for multiple future scenarios and will change accordingly to maintain momentum and minimize challenges. Design foresight, a method for determining possible, plausible, and predictable futures can guide this thinking. One or questions may be provided to the remote user terminals to obtain a user selected response relating to the adaptable characteristic for the product, service, brand, or organization.

The sustainable element may include a BX/Cx program design that includes thinking and methods that help a brand to be a better world citizen and more profitable, lasting business. These concepts are harmonious and can be implemented as a system to ensure long-term viability. One or questions may be provided to the remote user terminals to obtain a user selected response relating to the sustainable characteristic for the product, service, brand, or organization.

The viable element may be based on a concept that successful brands are profitable brands. Profits fuel innovation and inspire support inside and outside the organization. They also support longevity, which fosters brand equity. Solid BX/CX program design holds viability as a core tenet. One or questions may be provided to the remote user terminals to obtain a user selected response relating to the viable characteristic for the product, service, brand, or organization.

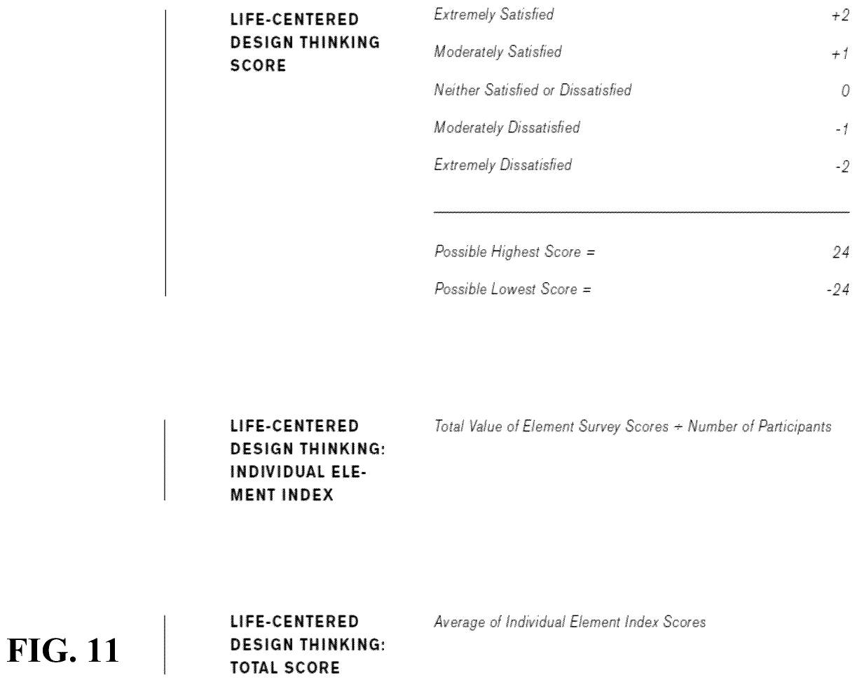

FIG. 11 illustrates an example of a numerical value that can be applied for each user selected phrase in response to the various questions provided to the user to determine a life-centered design thinking score. Once responses, e.g., user selections, are received from the multiple user terminals 104, the results may be automatically combined, including the automatic combination of scores from different remote user terminals to generates a combined measurement score and a benchmark to which the scores can be compared. For example, the benchmark may include a possible highest score and/or a possible lowest score. The highest possible score may be based on the number of responses received from participants multiplied by the highest value for a selectable response. Similarly, the lowest possible score may be based on the number of participants from which responses are received multiplied by the lowest value for a selectable response. For each element, e.g., as illustrated in FIG. 6, an individual element index score may be automatically calculated as responses are received from the users. The individual element index may include the total value of element survey scores divided by the number of participants. A total score may be automatically generated that is an average of the individual element index scores.

FIG. 6 illustrates the fiscal focus area including the feasible, rational, and understandable elements. The feasible element may assess whether an idea is capable of being built properly. The best idea in the world is valuable only if it is able to be realized. Is a product capable of being properly built? Is a service able to be expertly delivered? Each product or service ecosystem may be modeled, proven, and refined to assess whether the vision can be achieved. The rational element may assess a financial model, e.g., based on logic of markets, economics, and consumers. For example, financial models may be rooted in logic, such as the logic of markets, economics, and consumers. BX/CX programs may include a similar design, with similar rigor, to ensure that solutions that are identified respect the organizations financial goals. The understandable element may assess a sum, or combination, of the other aspects of the design program that is to be understandable. As an example, this element may assess whether the intended audience has an innate and correct response to the assessed aspect, and that the response is authentic and appropriate for the brand.

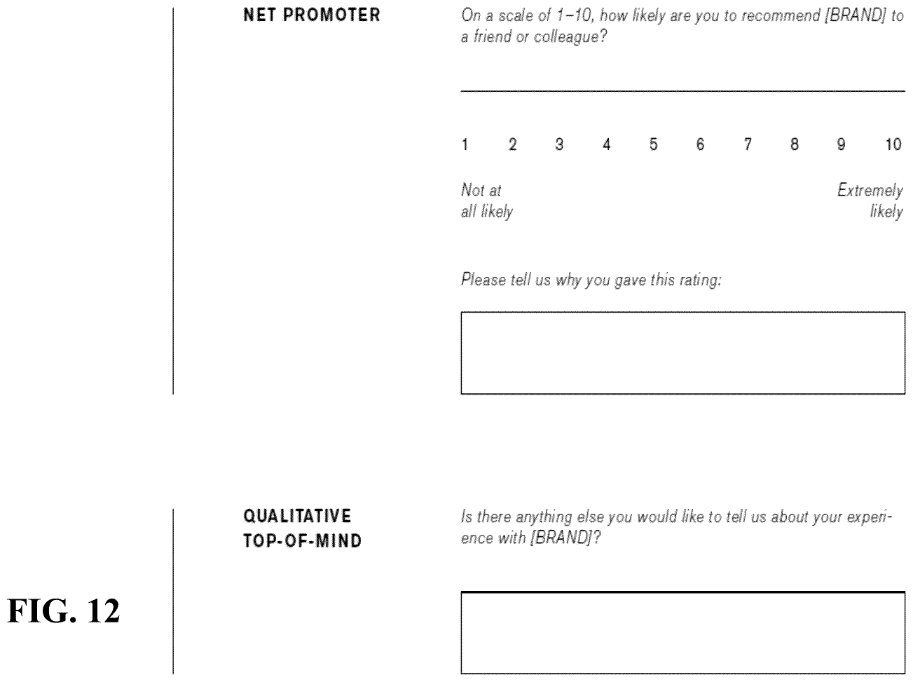

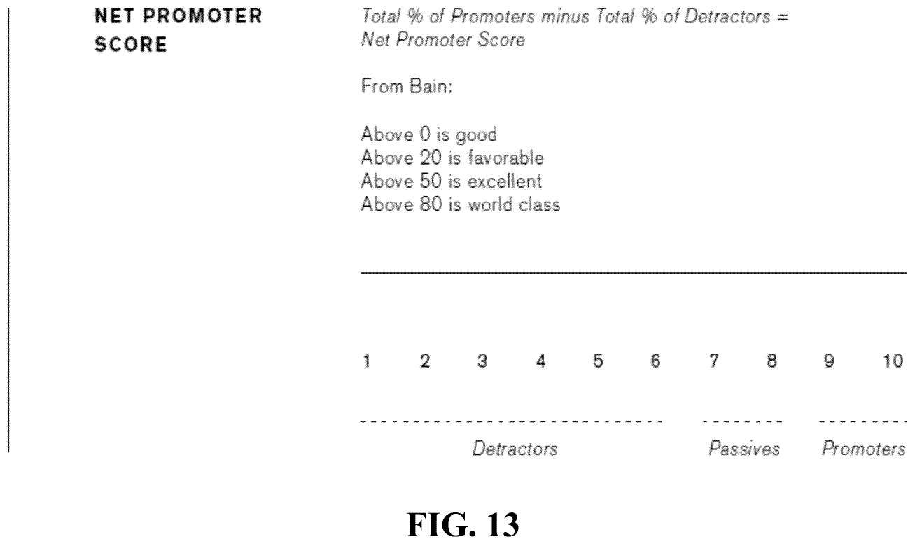

In addition to questions eliciting a response for each of the elements shown in FIG. 6, some additional questions may be presented, and/or options for the entry of text may be provided to the remote users. FIG. 12 illustrates that a net promotor question may be presented to the user, and the user selectable option may include a scale of values. FIG. 13 illustrates an example scale for a net promoter score and shows the grouping of values into groups of promoters, passives (e.g., that neither promote nor detract), and detractors. The user device may also display an entry box that enables the user to enter a description of a reason for the rating. Additionally, FIG. 12 shows that a qualitative top-of-mind question may be presented that asks the user if there is anything else that they would like to indicate about their experience with the particular brand, product, service, etc.

FIG. 14 illustrates an example spreadsheet report that may be automatically generated and/or updated as response are received at the system from the multiple remote terminals. In some aspects, the spreadsheet report may be provided to the organization 130, e.g., along with accompanying recommendations. FIG. 14 shows that individual element scores can be shown both for each individual user that provided a response, for groups, and/or combination values can be included in the report.

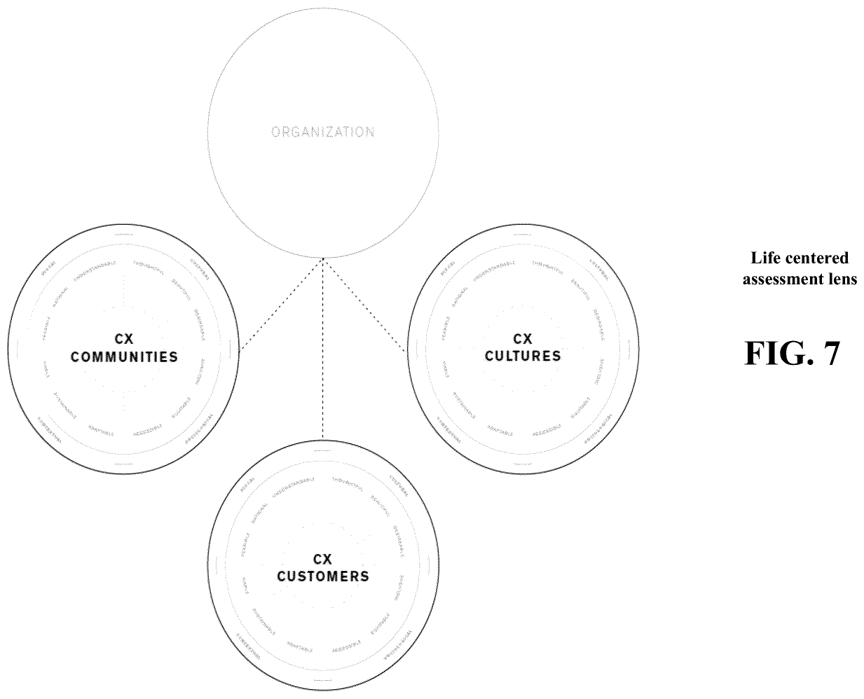

FIG. 7 illustrates that a multi-dimensional lens may be applied to the 3CX model to separately assess the customers, cultures, and communities using an individual lens having the focus areas and underlying elements described in connection with FIG. 6. For example, in a report, the responses from remote users may be classified based on different groups in which the user is considered a member, e.g., among customer, culture, and community, for example. The results may be separately compiled for each group of responses, and may be provided in separate reports, in separate portions of a report, etc.

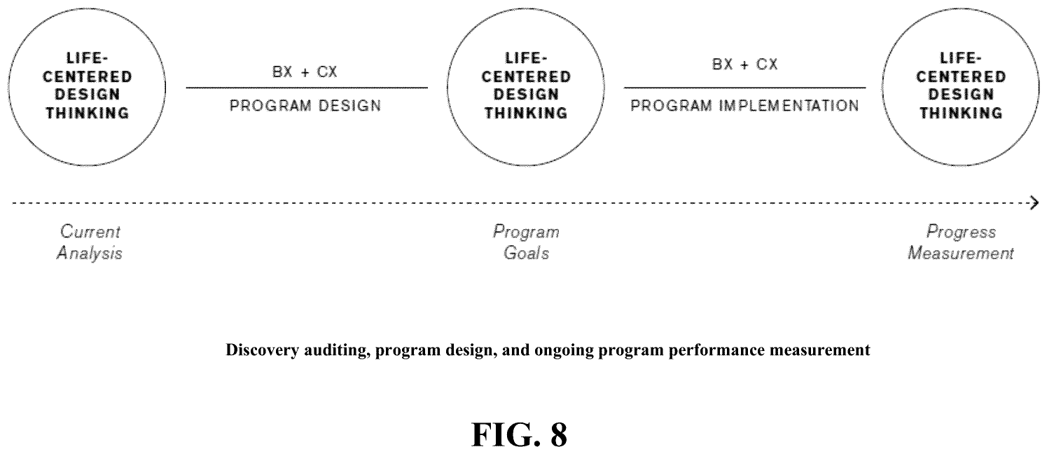

FIG. 8 illustrates that the tool, including sending inquiries to multiple users and combining responses per element and in an overall combination, may be used at various times including at design and assessment stages. For example, the tools presented herein may be used as part of a life-centered design for a brand of an organization, and may be used to generate a BX and CX program design. The tools may be used to generate program goals, and then may be used to measure and evaluate program implementation of the program goals. The measurement may include aspects of redesign, and the process of design, and measurement may be continued. Thus, the sets of questions may be sent out to the multiple remote user terminals at periodic times to receive response and automatically generate reports that measure design program goals. The sets of questions may be transmitted to the users at times based on a trigger, which may include a request from the organization.

As described herein, a measurement score may be determined for each element for each set of user responses. For each element, a set of scores may be generated as a part of program development and later measurement. FIG. 14 illustrates an example set of scores for an example organization or entity. The determined scores may be based on responses received from multiple participants (e.g., via a communication interface of the system 102 with multiple remote terminals 104 as shown in FIG. 1). FIG. 14 shows the participant responses grouped into 4 sets of groups, e.g., labeled as 001, 002, 003, and 004. Various groups may be queried to receive input response from one or more of the audiences described in connection with FIG. 5B. For example, one or more groups may be based on customers, cultures, and communities that interact with the organization being assessed. For each participant that provides user input, at least one query or question may be presented for each element assessed in the life-centered lens measurement. FIG. 14 illustrates a score assigned to the response(s) received for the elements from each person that enters input. In some aspects, the score may be based on a Likert scale. In other aspects, different scoring values or scales may be used.

A measurement or assessment may be based on a potential maximum score, as shown in FIG. 14, which is based on a number of participants that enter answers for the questions presented to assess the brand. A baseline score may be determined and stored, representing a score measured at program inception. A target score may be determined based on program goals, and a difference between the baseline score and the target score may be referred to as a target increase value. A progress score may be measured based on a later assessment of through the lens described in connection with FIG. 6. The progress score can be compared to the baseline and the target score to assess the progress may in brand intention and customer experience. As an example, a potential maximum may be 40 (shown in FIG. 14 for input from 20 participants), a baseline 10, and a target score may be 25 for a target increase of 15. These example scores, and the example showing 20 input responses is merely to illustrate the concept. The aspects presented herein may be applied for input received from any number of people, and the various groups may include different numbers of people. The potential maximum score is based on a maximum score input by each person from which input is received.

Once a progress score is determined and compared to a target score, various recommendations may be presented to the organization. For example, if the progress score is equal to or above the target score, the recommendation or report may be that the target goal has been achieved. If the progress score is higher than the baseline yet below the target score, the recommendation or report may indicate to maintain program momentum. If the progress score does not show improvement over the baseline, or shows less than a threshold level of improvement relative to the target score, the recommendation or report may indicate for the organization to revisit program measures to ensure consistency and effectiveness of the program. In some aspects, the automated report that is generated when the responses are received from the remote user terminals 104 may include visual indicators or highlights to represent a range or threshold relative to the different recommendation options. For example, if the score is within a range or meets a threshold, the element or score may be shown with a first color, if the score is outside the range or does not meet the threshold, a different color may be used. In some aspects, three colors may be used to enable the user to readily see whether the element scores, and/or combined scores, are meeting program goals, progressing toward program goals, or may indicate an adjustment could be helpful to the program.

The report may identify that a target goal is met, is within reach, or may indicate that a program can be adjusted or provided additional time to progress toward the achievement of a category goal. The indication may be separated per element that was assessed, and different indications can be included in a summary report based on the score for the particular element. In the example provided in FIG. 14, an example recommendation for the thoughtful element assessment, the report may indicate (1) target goal has been accomplished, (2) maintain program momentum, or (3) revisit measures in future to ensure consistency. For the beautiful element assessment, the report may indicate (1) target goal has been exceeded, (2) maintain program momentum, or (3) revisit measures in future to ensure consistency. For the desirable element assessment, the report may indicate (1) target goal is within reach or (2) determine if program requires tweaking or if additional time will enable the achievement of the category goal. The report and recommendations may be structured to provide information when there is relevant detail. In some aspects, instances can be deleted when there is no information to share or it is included and illustrated in other details. For the inclusive element assessment, the report may indicate (1) solid progress has been made, (2) more work needs to be done, the existing program approach may need augmentation, or (3) consider starting new employee research groups (ERGs) based on identity to provide further support for team members. For the equitable element assessment, the report may indicate (1) solid progress has been made, (2) more work needs to be done, the existing program approach may need augmentation, or (3) consider an annual profit sharing plan that will help team members feel more respected as well as more invested in the company's overall success. For the accessible element assessment, the report may indicate (1) progress has been made, but the program was starting in a meaningful deficit, (2) more work needs to be done, the existing program approach needs expansion, (3) consider additional modifications to physical workspaces in order to make people who are differently abled feel more welcome, or (4) consider developing an ERG for neurodiverse team members. The recommendations may be customized for a particular product, service, brand, or organization. The tools presented herein enable a collaborative, creative process of using design thinking methods to solve brand and organization problems. For the adaptable element assessment, the report may indicate (1) the program is encountering resistance at multiple levels within the organization, (2) consider how to engage organization leaders (e.g., which may be referred to as c-suite leaders) more effectively, changes will be driven top-down from the leadership to employees of the organization, or (3) a design foresight workshop might help executives to realize more fully the importance of this part of the program. For example, the recommendation may indicate design thinking methods, experience, or internal collaboration that may improve the adaptable element score. For the sustainable element assessment, the report may indicate (1) the program is encountering resistance at multiple levels within the organization, (2) consider how to engage c-suite leaders more effectively, changes will be driven top-down for the organization, or (3) consider how to more effectively drive sustainability as a significant factor to future success. For the viable element assessment, the report may indicate (1) solid progress has been made, (2) determine if the program can be adjusted or if addition time will enable the achievement of the category goal, or (3) consider leveraging the energy behind this viability facet of the contextual quadrant (focus area) to help motivate other elements (such as adaptable or sustainable). For the feasible element assessment, the report may indicate (1) solid progress has been made, (2) determine if the program can be adjusted or if additional time will enable the achievement of the category goal, or (3) the core vision of the organization and its products has a solid foundation, consider how this can be evolved and improved. For the rational element assessment, the report may indicate (1) the program target has been (or nearly has been) achieved, (2) maintain program momentum, or (3) revisit measures in future to ensure consistency. For the understandable element assessment, the report may indicate (1) meaningful progress has been made, (2) more work needs to be done, the existing program approach may need augmentation, or (3) consider refining the brand messaging approach to make it less technical and more emotional.

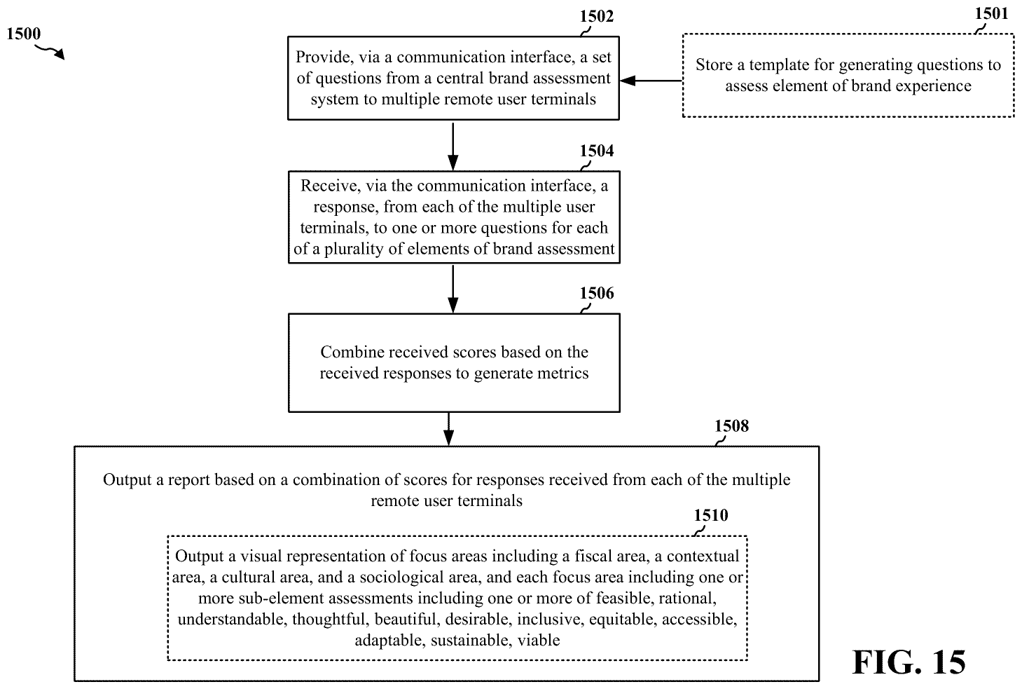

FIG. 15 is an example flowchart 1500 of a method of assessment of measuring brand experience and customer experience. The method may be performed at a decentralized customer instance. In some aspects, the method may be at a comprehensive brand design assessment system, e.g., 102. In various aspects, the methods described herein may be implemented in hardware, software, firmware, or any combination thereof. If implemented in software, the methods may be stored as one or more instructions or code on a non-transitory computer-readable medium that can be used to carry or store desired program code in the form of instructions or data structures and that can be accessed by one or more processors or a processing system.

As illustrated at 1502, the system provides, via a communication interface, a set of questions from the central system to multiple remote user terminals. The set of questions may include one or more questions directed to each of the focus areas and/or to each of the elements described in connection with the life-centered design lens in FIG. 6. FIGS. 10-13 illustrates examples of question types that may be presented to a user terminal. In some aspects, the questions may be presented at a user interface or a window of a display at the user terminal. The question may also be presented with a user selectable response that provides the user's assessment relating to that element or focus area for a brand, a product, or a service of an organization. As described in connection with FIGS. 5B and 7, and/or 14, the questions may be directed to multiple groups of user terminals, e.g., based on one or more of the customer, culture, and community grouping. In some aspects, the provision of the set of questions may be provided by the brand design assessment report component 1675 described in connection with FIG. 16 or the question generation component 210 described in connection with FIG. 2.

As illustrated at 1504, the system may then receive, via the communication interface, a response from each of the multiple user terminals. For example, when a user selects one of the presented response options, the response may be provided from the user terminal to the central system and stored in connection with an indication of the corresponding brand, product, or service being assessed. In some aspects, the responses may be received and/or stored by the brand design assessment report component 1675 described in connection with FIG. 16 or the response and scoring component 212 described in connection with FIG. 2.

As illustrated at 1506, the central system combines the scores based on the received response to generate metrics for assessed elements of the life-centered brand design. In some aspects, the user selectable response may include a range or a number, and a score may be based on a combination of the received ranges or numbers. In some aspects, the user selectable response may include a written description. In such aspects, the written descriptions of the different options may be associated with a number value for a score, and the corresponding number values may be combined to obtain the score for the element. As described in connection with FIG. 14, the metrics may include a maximum possible score for each element, a total or average score per element, a deviation, among other example metrics that may be generated. In some aspects, the compilation of the scores based on the received responses from the multiple user terminals may be automatically performed and saved, as the responses arrive. In some aspects, the combined scoring information may be updated as additional responses are received. In some aspects, the combination and determination of the metrics may be provided by the brand design assessment report component 1675 described in connection with FIG. 16 or the response and scoring component 212 described in connection with FIG. 2.

As illustrated at 1508, the central system may output a report based on the combination of scores. The report may be output to a user at the central system or may be stored and a notification may be provided to the user at the central system. In some aspects, the report may be output to the organization or made available to the organization, e.g., and the organization may access the report. In some aspects, the report may be generated with customization entered by a user. As illustrated at 1510, in some aspects, the report may be output with a visual representation of scores determined for the focus areas including a fiscal area, a contextual area, a cultural area, and a sociological area, and each focus area including scores for one or more sub-element assessments including one or more of feasible, rational, understandable, thoughtful, beautiful, desirable, inclusive, equitable, accessible, adaptable, sustainable, and/or viable. In some aspects, the output may be performed by the brand design assessment report component 1675 described in connection with FIG. 16 or the report and recommendation component 214 described in connection with FIG. 2.

The report may include sub-reports for multiple groups of responses, e.g., based on multiple groups from customers, culture, or community groups. The reports may be customized with recommendations based on the metrics. In some aspects, the recommendations may be automatically generated based on ranges of scores or threshold scores. In some aspects, the recommendations may be entered by a user and stored with the report. The recommendations may include any of the recommendation examples described herein.

As illustrated at 1501, in some aspects, the system may store a template for generating questions to assess the elements of brand experience. The questions at 1502 may be generated based on the template with customizations for an individual product, service, brand, or organization, in order to receive more targeted responses from the users via the remote user terminals. In some aspects, the storage, maintenance, and/or update of the template may be provided by the brand design assessment report component 1675 described in connection with FIG. 16.

FIG. 16 is a block diagram illustrating a general-purpose computer system 1620 on which aspects of systems and methods for providing sets of questions for assessing brand and customer experience, receiving the user selected responses, generating a combined set of scores based on the received responses, and providing an output report, e.g., as described in connection with any of FIGS. 1-15 may be implemented in accordance with an example aspect. The computer system 1620 can correspond to the physical server(s) on which the system 102 is executed, for example, as described herein.

As shown, the computer system 1620 (which may be a personal computer or a server) may include a central processing unit 1621, a system memory 1622, and a system bus 1623 connecting the various system components, including the memory associated with the central processing unit 1621. As will be appreciated by those of ordinary skill in the art, the system bus 1623 may comprise a bus memory or bus memory controller, a peripheral bus, and a local bus that is able to interact with any other bus architecture. The system memory may include permanent memory (ROM) 1624 and random-access memory (RAM) 1625. The basic input/output system (BIOS) 1626 may store the basic procedures for transfer of information between elements of the computer system 1620, such as those at the time of loading the operating system with the use of the ROM 1624.

The computer system 1620 may also comprise a hard disk 1627 for reading and writing data, a magnetic disk drive 1628 for reading and writing on removable magnetic disks 1629, and an optical drive 1630 for reading and writing removable optical disks 1631, such as CD-ROM, DVD-ROM and other optical media. The hard disk 1627, the magnetic disk drive 1628, and the optical drive 1630 are connected to the system bus 1623 across the hard disk interface 1632, the magnetic disk interface 1633, and the optical drive interface 1634, respectively. The drives and the corresponding computer information media are power-independent modules for storage of computer instructions, data structures, program modules, and other data of the computer system 1620.

An example aspect comprises a system that uses a hard disk 1627, a removable magnetic disk 1629 and a removable optical disk 1631 connected to the system bus 1623 via the controller 1655. It will be understood by those of ordinary skill in the art that any type of media 1656 that is able to store data in a form readable by a computer (solid state drives, flash memory cards, digital disks, random-access memory (RAM) and so on) may also be utilized.

The computer system 1620 has a file system 1636, in which the operating system 1635 may be stored, as well as additional program applications 1637, other program modules 1638, and program data 1639. A user of the computer system 1620 may enter commands and information using keyboard 1640, mouse 1642, or any other input device known to those of ordinary skill in the art, such as, but not limited to, a microphone, joystick, game controller, scanner, etc. Such input devices typically plug into the computer system 1620 through a serial port 1646, which in turn is connected to the system bus, but those of ordinary skill in the art will appreciate that input devices may be also be connected in other ways, such as, without limitation, via a parallel port, a game port, or a universal serial bus (USB). A monitor 1647 or other type of display device may also be connected to the system bus 1623 across an interface, such as a video adapter 1648. In addition to the monitor 1647, the personal computer may be equipped with other peripheral output devices (not shown), such as loudspeakers, a printer, etc.

Computer system 1620 may operate in a network environment, using a network connection to one or more remote computers 1649. The remote computer (or computers) 1649 may be local computer workstations or servers comprising most or all of the aforementioned elements in describing the nature of a computer system 1620. Other devices may also be present in the computer network, such as, but not limited to, routers, network stations, peer devices or other network nodes.

Network connections can form a local-area computer network (LAN) 1650 and a wide-area computer network (WAN). Such networks are used in corporate computer networks and internal company networks, and they generally have access to the Internet. In LAN or WAN networks, the computer system 1620 is connected to the local-area network 1650 across a network adapter or network interface 1651. When networks are used, the computer system 1620 may employ a modem 1654 or other modules well known to those of ordinary skill in the art that enable communications with a wide-area computer network such as the Internet. The modem 1654, which may be an internal or external device, may be connected to the system bus 1623 by a serial port 1646. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module, element, or component may also be implemented as a combination of the two, with particular functions facilitated by hardware alone, and other functions facilitated by a combination of hardware and software. In particular implementations, at least a portion, and in some cases, all, of a module, element, or component may be executed on one or more processors of a general purpose computer. Accordingly, each module may be realized in a variety of suitable configurations, and should not be limited to any particular implementation or example herein. An element, or any portion of an element, or any combination of elements may be implemented as a “processing system” that includes one or more processors. When multiple processors are implemented, the multiple processors may perform the functions individually or in combination. One or more processors in a processing system may execute stored instructions, which may be referred to as software, firmware, middleware, microcode, hardware description language, or otherwise, e.g., instructions, instruction sets, code, code segments, program code, programs, subprograms, software components, applications, software applications, software packages, routines, subroutines, objects, executables, threads of execution, procedures, functions, or any combination thereof.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

The following aspects are illustrative only and may be combined with other aspects or teachings described herein, without limitation.

Aspect 1 is method of assessing brand experience and customer experience, comprising: providing, via a communication interface, a set of questions for a multiple element brand design assessment from a central system to multiple remote user terminals; receiving, via the communication interface, a set of user selectable response from each of the multiple remote user terminals in response to the provided set of questions; combining scores based on the set of user selectable responses receive from each of the multiple remote user terminals to generate metrics for assessed elements of the multiple element brand design assessment; and outputting a report comprising the metrics for the assessed elements of the multiple element brand design assessment.

In aspect 2, the method of aspect 1 further includes that the multiple element brand design assessment comprises a life-centered brand design assessment.

In aspect 3, the method of aspect 1 or 2 further includes that the multiple remote user terminals are associated with multiple types of users based on two or more of customers, culture, and community associated with a brand, product, service, or organization that is a subject of the multiple element brand design assessment.

In aspect 4, the method of any of aspects 1-3 further includes that the set of questions includes one or more question for each of multiple focus areas including a fiscal area, a cultural area, a sociological area, and a contextual area.

In aspect 5, the method of aspect 4 further includes that the set of questions includes one or more questions for each element in a category associated with the multiple focus areas.

In aspect 6, the method of aspect 4 or 5 further includes that the set of questions includes the one or more questions to elicit a user selectable response relating to a brand, product, service, or organization for one or more elements including feasible, rational, understandable, thoughtful, beautiful, desirable, inclusive, equitable, accessible, adaptable, sustainable, or viable.

In aspect 7, the method of aspect 4 or 5 further includes that the set of questions includes the one or more questions to elicit a user selectable response relating to a brand, product, service, or organization for each of element of feasible, rational, understandable, thoughtful, beautiful, desirable, inclusive, equitable, accessible, adaptable, sustainable, and viable.

In aspect 8, the method of any of aspects 4-7 further includes that the metrics include a combined score for each element, a maximum possible score for each element, and a deviation score for each element.

In aspect 9, the method of any of aspects 1-8 further includes storing a template for sets of questions for the multiple element brand design assessment, wherein the set of questions provided to the multiple remote user terminals is based on the template.

Aspect 10 is a system for assessing brand experience and customer experience, comprising: at least one memory; and at least one processor coupled to the at least one memory, the at least one processor, individually or in any combination, is configured to perform the method of any of aspects 1 to 9.

Aspect 11 is a computer-readable medium (e.g., a non-transitory computer-readable medium) storing computer executable code at a central system, the code when executed by at least one processor causes the central system to perform the method of any of aspects 1 to 9.

What is claimed is:

1. A non-transitory computer-readable medium storing computer executable code for information modeling, the code when executed by processor circuitry causes a central processing system to:
provide, via a communication interface, a set of questions for a multiple element brand design assessment from a central system to multiple remote user terminals;
receive, via the communication interface, a set of user selectable responses from each of the multiple remote user terminals in response to the provided set of questions;
combine scores based on the set of user selectable responses receive from each of the multiple remote user terminals to generate metrics for assessed elements of the multiple element brand design assessment; and
output a report comprising the metrics for the assessed elements of the multiple element brand design assessment.

2. The non-transitory computer-readable medium of claim 1, wherein the multiple element brand design assessment comprises a life-centered brand design assessment.

3. The non-transitory computer-readable medium of claim 1, wherein the multiple remote user terminals are associated with multiple types of users based on two or more of customers, culture, and community associated with a brand, product, service, or organization that is a subject of the multiple element brand design assessment.

4. The non-transitory computer-readable medium of claim 1, wherein the set of questions includes one or more question for each of multiple focus areas including a fiscal area, a cultural area, a sociological area, and a contextual area.

5. The non-transitory computer-readable medium of claim 4, wherein the set of questions includes one or more questions for each element in a category associated with the multiple focus areas.

6. The non-transitory computer-readable medium of claim 5, wherein the set of questions includes the one or more questions to elicit a user selectable response relating to a brand, product, service, or organization for one or more elements including feasible, rational, understandable, thoughtful, beautiful, desirable, inclusive, equitable, accessible, adaptable, sustainable, or viable.

7. The non-transitory computer-readable medium of claim 5, wherein the set of questions includes the one or more questions to elicit a user selectable response relating to a brand, product, service, or organization for each of element of feasible, rational, understandable, thoughtful, beautiful, desirable, inclusive, equitable, accessible, adaptable, sustainable, and viable.

8. The non-transitory computer-readable medium of claim 6 or 7, wherein the metrics include a combined score for each element, a maximum possible score for each element, and a deviation score for each element.

9. The non-transitory computer-readable medium of claim 1, wherein the code when executed by the processor circuitry further causes the central processing system to:
store a template for sets of questions for the multiple element brand design assessment, wherein the set of questions provided to the multiple remote user terminals is based on the template.

10. A method of assessing brand experience and customer experience, comprising:
providing, via a communication interface, a set of questions for a multiple element brand design assessment from a central system to multiple remote user terminals;
receiving, via the communication interface, a set of user selectable response from each of the multiple remote user terminals in response to the provided set of questions;
combining scores based on the set of user selectable responses receive from each of the multiple remote user terminals to generate metrics for assessed elements of the multiple element brand design assessment; and
outputting a report comprising the metrics for the assessed elements of the multiple element brand design assessment.

11. The method of claim 10, wherein the multiple element brand design assessment comprises a life-centered brand design assessment.

12. The method of claim 10, wherein the multiple remote user terminals are associated with multiple types of users based on two or more of customers, culture, and community associated with a brand, product, service, or organization that is a subject of the multiple element brand design assessment.

13. The method of claim 10, wherein the set of questions includes one or more question for each of multiple focus areas including a fiscal area, a cultural area, a sociological area, and a contextual area.

14. The method of claim 13, wherein the set of questions includes one or more questions for each element in a category associated with the multiple focus areas.

15. The method of claim 14, wherein the set of questions includes the one or more questions to elicit a user selectable response relating to a brand, product, service, or organization for one or more elements including feasible, rational, understandable, thoughtful, beautiful, desirable, inclusive, equitable, accessible, adaptable, sustainable, or viable.

16. The method of claim 14, wherein the set of questions includes the one or more questions to elicit a user selectable response relating to a brand, product, service, or organization for each of element of feasible, rational, understandable, thoughtful, beautiful, desirable, inclusive, equitable, accessible, adaptable, sustainable, and viable.

17. The method of claim 15 or 16, wherein the metrics include a combined score for each element, a maximum possible score for each element, and a deviation score for each element.

18. The method of claim 10, further comprising:
storing a template for sets of questions for the multiple element brand design assessment, wherein the set of questions provided to the multiple remote user terminals is based on the template.
